(19) United States
(12) Patent Application Publication
(10) Pub. No.: US 2016/0199876 A1
(43) Pub. Date: Jul. 14, 2016

(54) PLASMA TREATMENT OF THERMOSET FILLER PARTICULATE

(71) Applicant: CONTINENTAL STRUCTURAL PLASTICS, INC., Michigan, MI (US)

(72) Inventors: Frank Macher, Auburn Hills, MI (US); Probir Kumar Guha, Bloomfield Hills, MI (US)

(21) Appl. No.: 14/917,107

(22) PCT Filed: Oct. 30, 2014
(86) PCT No.: PCT/IB2014/002294

§ 371 Date: Mar. 7, 2016

Related U.S. Application Data
(60) Provisional application No. 61/874,777, filed on Sep. 6, 2013.

(51) Int. Cl. B05D 1/22; B05C 19/02

(52) U.S. Cl. CPC B05D 1/22; B05C 19/02

(57) ABSTRACT

A method for forming an article from a thermoset resin containing particle filler of glass microspheres is provided and includes exposing the particle filler to plasma to increase activation sites on the particle filler; and crosslinking said particle filler to the thermoset set resin via the activation sites. The method provides an exemplary method for treating thermoset fillers to promote bonding to a thermoset matrix. The present invention further provides an apparatus for treating thermoset fillers to promote bonding to a thermoset matrix which includes a fluidized bed reactor; at. least one gas source; at least, one valve for isolating said one gas source: and at least one gas inlet in fluid communication with said at least one gas source for gas delivery to said a fluidized bed reactor.

### CROSS REFERENCE TO RELATED APPLICATIONS

This application claims priority to U.S. Provisional Application No. 61/874,777 filed Sep. 6, 2013, the contents of which is incorporated herein by reference as if explicitly and fully expressed herein.

### FIELD OF THE INVENTION

The present invention in general relates to plasma treatment of filler materials and in particular to plasma treatment of microsphere filler particulate.

### BACKGROUND OF THE INVENTION

The economic and environmental pressures to produce vehicles that are lighter and stronger have only accelerated in the past few years. While vehicle weight savings were traditionally achieved by migrating from steel components to aluminum, and even with resorting to newly engineered structures with reinforced stress points to account for the use of less metal, the ability to glean additional weight saving from aluminum components is diminishing.

Sheet molding compositions and resin transfer moldings that are based on thermoset resin matrices have a lower inherent density than aluminum. The ability to mold complex components also represents a potential advantage over other lightweight materials, such as aluminum. However, thermoset made components have made only sporadic inroads in the replacement of aluminum vehicle components when thermoset resins are reinforced with high loads of inorganic particulate and glass fibers which increase the overall density of the component. The usage of polymeric fillers and hollow glass microspheres reduce the density of thermoset resin based vehicle components and are even able to achieve the high sheen surfaces demanded for vehicle exterior body panels.

U.S. Pat. No. 7,700,670 is representative of this effort. Yet thermoset resin based vehicle components could achieve greater market acceptance with higher strength components. While U.S. Pat. No. 7,700,670 teaches the use of surface modification of such low density fillers to cross link the fillers to the thermoset resin and thereby increase the strength of the resulting component, the number of active sites present on surface of such filler particles is often less than desired to achieve optimal component strength.

Fillers, under ambient conditions are often contaminated by adsorbed hydrocarbons and dust particles. Such contamination may result, in reduced adhesion between matrix and the filler surface. Therefore it is important to ensure a certain level of filler surface cleanliness There are several cleaning methods available: dust particles can be blown, rubbed or washed away, for example by sonicating in organic solvents such as acetone and various alcohols. To remove organic contamination various wet cleaning procedures can be chosen, such as UV and ozone, to name a few. Most often the wet cleaning procedures resort to the use of organic solvents and/or strong acids and bases; these are environmentally disfavored. Advantages of the plasma cleaning are the lower production of hazardous waste and the shorter treatment times.

While plasma cleaning of glass surfaces is well known, there has been little attention paid to the creation of active surface sites on filler particle surfaces as a preliminary to covalently bonding a coupling agent to the filler surface so as to achieve bonding between the coupling agent and the matrix during thermoset cure. Powder plasma reactors have been developed largely for small batch experimental uses (K. Tsusui, K. Nishizawa and S. Ikeeda, Plasma Surface Treatment of an Organic Pigment, Journal Coatings of Technology 69 (1988) 107) and generally are not suitable for uniformly increasing the bonding sites on filler particles such as glass microspheres, as needed in the thermoset resin molding industry.

Thus, there exists a need for a process to treat thermoset fillers to promote bonding to a thermoset matrix. There further exists for a need to provide an apparatus capable of treating thermoset fillers to promote bonding to a thermoset matrix.

### SUMMARY OF THE INVENTION

An inventive method for forming an article from a thermoset resin containing particle filler is provided and includes exposing the particle filler to plasma to increase activation sites on the particle filler; and crosslinking said particle filler to the thermoset set resin via the activation sites. Plasma exposure is performed within a plasma exposure is within a fluidized bed reactor. The increase in activation sites are measured by iodometry.

The present invention further provides an apparatus for treating thermoset fillers to promote bonding to a thermoset matrix which includes a fluidized bed reactor; at least one gas source; at least one valve for isolating said one gas source; and at least one gas inlet in fluid communication with said at least one gas source for gas delivery to said a fluidized bed reactor.

### BRIEF DESCRIPTION OF THE DRAWINGS

FIG. 1 is a schematic view illustrating an example of the apparatus used in the practice of the invention.

### DETAILED DESCRIPTION OF THE INVENTION

The present invention has utility in the plasma treatment of filler particulate uniformly to increase bonding sites for coupling to a thermoset matrix. A fluidized bed plasma treatment reactor has been found to afford simultaneous and uniform active site generation around a three-dimensional filler particle.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

The generation of the plasma introduces the energy necessary to the filler particle surface for forming free radicals that result in bonding sites on the surface of particles. While it is appreciated that this filler surface activation process can occur in a fluidized bed thereby facilitating the use of cold plasma, it is appreciated that hot plasma exposure is also suitable for filler surface activation.

For example, the temperature of hot plasma generation is approximately 1000° C.

The separation of the fluidized bed from the generation of the plasma, and the reduction in pressure results in the filler particles being exposed to distinctly lower temperatures, as many filler particles used in thermoset matrices are degraded by exposure to such high temperatures. While plasma is readily generated at a variety of pressures from 0.00001 to 1 atmosphere (atm), in certain inventive embodiments, the plasma generating pressure ranges from 0.0001 to 0.1 atm for generating the plasma, and 0.001 to 0.1 atm in the fluidized bed. Surface activation of the filler particles occurs at temperatures as low as 20° C. Typically, surface activation temperatures range from 20-250° C. In still other embodiments surface activation temperatures range from 40-200° C.

Plasma generation occurs in a variety of gases, with the choice of gas being dictated by the type of surface activation desired. By way of example, processes requiring ion bombardment as a primary mechanism—such as reactive ion etching—the power density to the plasma, expressed in units of Watts per cubic centimeter per kilopascal (kPa) of pressure, will be higher than for processes where neutral species only are required, such as deposition of oxygen species. Typically, ion-based processes have power densities that are roughly between about 3 and 100 W/cm³/kPa, while neutral-based processes have densities between about 0.1 and about 10 W/cm³/kPa.

As most filler particles for thermoset matrices are amenable to formation of increased oxygen reactive moieties of hydroxyl, single oxygen, and peroxides; air or di-oxygen gas based plasmas are well suited for increasing reactive sites on filler particles such as glass microspheres that are solid or hollow; silica particles; inorganic carbonates; organic fillers; natural cellulosic fillers such as hemp, cane, bamboo, jute, straw, silk, straw sawdust, nutshells, grain husks, grass, palm frond, coconut husk, coconut fiber and combinations thereof. It is appreciated that natural fillers are readily provided in the form of fibers or ground into forms approaching spherical in shape. Ion bombardment induced activation is readily performed with inert gases such as nitrogen, neon, or argon. In some inventive embodiments, a chemical vapor deposition (CVD) precursor is added to the gas in the fluidized bed to add specific functionality to the filler particle surfaces.

The process for adding active sites for covalently bonding to a thermoset matrix is described in detail with the aid of reference to the diagram in the figure. It should be appreciated that the representations provided in the figures are not depicted to scale of the purpose of visual clarity.

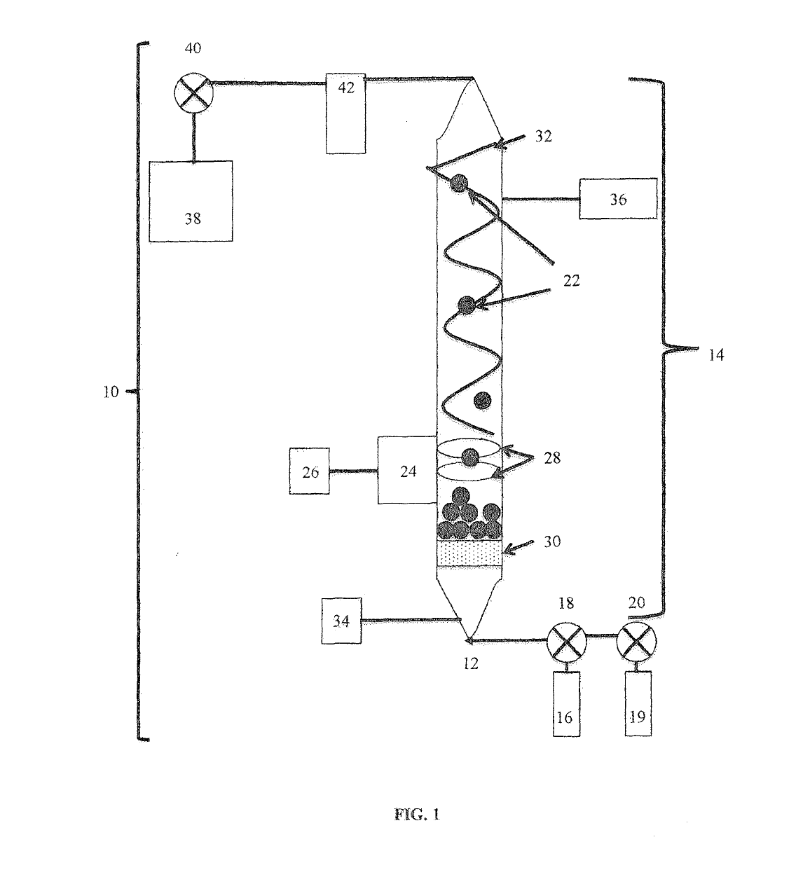

Referring now to FIG. 1, the apparatus is shown generally at 10 and includes a gas inlet 12 for gas delivery to a fluidized bed reactor 14. The gas inlet 12 is also in fluid communication with a first gas source 16 by way of a valve 18. The gas source is illustratively oxygen, nitrogen, air, argon or mixtures containing any of the aforementioned gases. In some inventive embodiments, a second gas source 19 that varies from the first gas source 16 is provided to the gas inlet 12 by way of a second valve 20. In at least one embodiment, the second gas source is a CVD precursor that reacts in the plasma to deposit a coating onto the filler particulate 22 within the reactor 14.

The reactor's 14 vessel or container is readily constructed of quartz, borosilicate glass, or other glasses and ceramics generally known in the art. While the reactor 14 is depicted in a vertical orientation, it is appreciated that in other embodiments, the reactor 14 is oriented in a generally horizontal orientation. Without intending to be bound by a particular theory, it is appreciated that a horizontal orientation of the reactor 14 facilitates inclusion of a feed hopper analogous to an injection molding material delivery system.

In a specific embodiment, the plasma is generated; for example, by a conventional magnetron 24 powered by a direct current or alternating current power supply 26. It is appreciated that the plasma is also readily generated by radiofrequency inductive coupling inside a coil 28. Typical RF frequencies for a coil 28 range from 5 kHz to 50 MHz.

The particulate 22 is placed on a porous base 30 which permits the gas to flow through, while supporting the weight of the particulate 22. An adjutator 32 in the form of a stirrer or auger is present in some inventive embodiments promotes uniform exposure of the particulate 22 to the plasma. The adjutator 32 in some embodiments transits through the plasma generation zone while in other embodiments, an adjutator 32 is located outside the plasma generation zone and powered by a motor 34. In still other embodiments, turbid gas flow is sufficient to assure uniform exposure of the surfaces of particle to activation treatment.

A pressure control pump 38 is provided with a pressure control valve 40 and a pressure control trap 42 to control the overall pressure in the reactor 14. A pressure gauge 36 monitors pressure in the reactor 14 and in some embodiments provides feedback control to pressure control valve 40, the plasma generator power supply 26, the gas valves 18 or 20, or a combination thereof.

The stability of the plasma, the heat stress on the particles, particle surface area, particle loading, and the homogeneity and quality of the activation of the particles 22 are influenced by the pressure and gas flow conditions within the plasma and in the fluidized bed. Determination of a desired level of activation is measured by iteration with iodometry titration, or simply reaction with coupling agents to the activated particles and testing of final thermoset article properties. In some embodiments, in order to reduce the temperature further, to cool the gas during generation of the plasma, jacketed cooling tubes are employed that charged with a suitable gaseous or liquid coolant. Air and water are exemplary gaseous and liquid coolant fluids.

### EXAMPLES

The present invention is further detailed with respect to the following examples that are not intended to limit the scope of the claimed invention, but rather to illustrate specific aspects of the invention.

### Example 1

Production of activated glass microspheres

Hollow glass microspheres having a diameter of 16 microns are tested by iodometry and subjected to oxygen plasma treatment with an increase in active sites as measured by iodometry to have increased by a factor of 90. The reactor is operated at about 80° C. under about 0.0002 atm. Plasma-activated oxygen radicals are generated with volume flows under standard conditions were about 560 ml/min. The particle exposure lasted 30 minutes. The resulting activated glass microspheres chemically bond to the alkoxysilane surface coupling agent 3-glycidoxypropyltrimethoxysilane. Upon cure in a standard styrene based SMC matrix, the resulting material has superior paint adhesion as measured by scored paint removed with an adhesive tape.

The foregoing description is illustrative of particular embodiments of the invention, but is not meant to be a limitation upon the practice thereof. The following claims, including all equivalents thereof, are intended to define the scope of the invention.

1. A process of forming an article from a thermoset resin containing fiber or particle filler comprising:
exposing the fiber or particle filler to plasma in a fluidized bed reactor to increase activation sites on the fiber or particle filler; and
crosslinking the fiber or particle filler to the thermoset set resin via the activation sites.

2. The process of claim 1 wherein the fiber or particle filler are glass microspheres.

3. The process of claim 1 further comprising measuring the increase in activation sites by iodometry.

4. The process of claim 1 wherein the fiber or particle filler are hollow glass microspheres.

5. The process of claim 1 wherein the plasma is cold plasma, hot plasma or combinations thereof.

6. The process of claim 1 further comprising agitating the fiber or particle filler during the exposure to the plasma.

7. An apparatus for treating thermoset fillers to promote bonding to a thermoset matrix, the apparatus comprising:
a fluidized bed reactor;
at least one gas source;
at least one valve for isolating said one gas source;
at least one gas inlet in fluid communication with said at least one gas source for gas delivery to said a fluidized bed reactor.

8. The apparatus of claim 7, wherein said fluidized bed reactor comprises a reactor vessel, a porous base, and filler particulate.

9. The apparatus of claim 8, wherein said reactor vessel is constructed of glass or ceramic or combinations thereof.

10. The apparatus of claim 9, wherein said reactor is constructed of quartz or borosilicate glass.

11. The apparatus of claim 7 wherein the said at least one gas source is oxygen, nitrogen, air, argon, CVD precursor, combinations thereof, or gas mixtures containing the foregoing.

12. The apparatus of claim 7 further comprising a second gas source that is a different gas source from the said at least one gas source.

13. The apparatus of claim 12 wherein the said second gas source is a CVD precursor that reacts in the plasma to deposit a coating onto the filler particulate within the reactor.

14. The apparatus of claim 7, wherein the reactor is oriented in a vertical orientation or horizontal orientation, or any orientation therebetween.

15. The apparatus of claim 7 further comprising a plasma generator.

16. The apparatus of claim 15 wherein the plasma generator comprises a magnetron powered by a direct current or alternating current power supply, or the plasma generator comprises radiofrequency inductive coupling inside a coil.

17. The apparatus of claim 16 wherein the radiofrequencies range from 5 kHz to 50 MHz.

18. The apparatus of claim 8 wherein the reactor further comprises an adjutator in the form of a stirrer or auger to promote uniform exposure of the particulate to the plasma.

19. The apparatus of claim 18 wherein said adjutator transits the reactor internally through the plasma generation zone or said adjutator is located outside the plasma generation zone and powered by a motor.

20. The apparatus of claim 8 wherein said reactor further comprises a pressure control pump, a pressure control valve, a pressure control trap, and a pressure gauge.
